(19) United States
(12) Patent Application Publication
(10) Pub. No.: US 2017/0139969 A1
(43) Pub. Date: May 18, 2017

(54) METHOD FOR FILTERING AND ANALYZING BIG DATA, ELECTRONIC DEVICE, AND NON-TRANSITORY COMPUTER-READABLE STORAGE MEDIUM

(71) Applicants: LE HOLDINGS (BEIJING) CO., LTD., Beijing (CN); LECLOUD COMPUTING CO., LTD., Beijing (CN)

(72) Inventors: Youming Zhang, Beijing (CN); Meng Zhou, Beijing (CN)

(21) Appl. No.: 15/248,592

(22) Filed: Aug. 26, 2016

Related U.S. Application Data
(63) Continuation of application No. PCT/CN2016/083187, filed on May 24, 2016.

(30) Foreign Application Priority Data
Nov. 13, 2015 (CN) 201510779664.7

(51) Int. Cl. G06F 17/30

(52) U.S. Cl. CPC G06F 17/30345; G06F 17/30309

(57) ABSTRACT

A method for filtering and analyzing big data and electronic device are provided. The method includes multiple rounds of filtering and analyzing. Each round of filtering and analyzing includes: filtering and analyzing a set of data to be filtered, according to a filtering dimension which was not selected; and saving data corresponding to at least one dimension item under the filtering dimension and satisfying at least one target requirement as a set of data to be filtered in a next round of filtering and analyzing. The number of the multiple rounds of filtering and analyzing is determined based on the number of filtering dimensions and target requirements. Accordingly, a system will not crash due to being heavily loaded with large amount of data, and the accuracy of filtering and analyzing is improved.

### CROSS REFERENCE TO RELATED APPLICATIONS

This application is a continuation of International Application No. PCT/CN2016/083187, filed on May 24, 2016, which is based upon and claims priority to Chinese Patent Application No. 201510779664.7, filed on Nov. 13, 2015, the entire contents of each of which are incorporated herein by reference.

### TECHNICAL FIELD

The disclosure relates to the field of data analysis, and more particularly, to a method for filtering and analyzing big data, an electronic device, and a non-transitory computer-readable storage medium.

### BACKGROUND

Big data emerges with rapid development of “informationization.” In order to overcome the shortcomings, with which conventional approaches cannot cope as big data is very large in size and is non-structural, cloud computing has been developed. Information storage, sharing, and digging based on cloud computing can store a large amount of high speed and diverse big data in an economical and effective manner. However, it has become a hot topic regarding how to filter these data and use the filtering results to guide decision making of an enterprise from different dimensions.

Conventionally, methods for filtering and analyzing data only analyze data under a single dimension, or perform combined filtering under multiple dimensions. The drawback of filtering under a single dimension is that an information point is hard to identify if it is hidden under multiple dimensions. The drawback of combined filtering is that, when a dimension item is determined for performing data analysis, selection of the dimension item depends to a large extent on experiences of the person making the selection, making it likely to make a wrong selection. For either filtering under a single dimension or filtering under combined dimensions, if a final result cannot be obtained due to making a wrong selection of the filtering dimension during the filtering process, filtering needs to be performed anew, thereby significantly affecting the filtering efficiency.

For example, in the field of videos, traffic amounts of target information or stutters are monitored and analyzed typically on an operating platform by combining different filtering dimensions, including region, city, operating system, browser, sex, age group, etc. Conventional monitoring methods select from all filtering dimensions respective items based on prior experiences, to perform combined filtering and analyzing on the target information. If the target information happens to be the problematic information point, then the monitoring is completed. Otherwise, other permutations and combinations of filtering dimension items are selected to perform filtering and analyzing to complete the monitoring. Although these methods enable information, such as amounts of video traffic and video stutters, to be monitored, the amount of information to be processed during the entire processing procedure is large, causing the processor to be heavily loaded, which results in low-processing efficiency and prevents popularization and application of the methods. Moreover, even if a doubtfully problematic information point is found using these methods, it is hard to confirm the information point as the optimal one, as there is a large amount of other possible permutations and combinations.

### SUMMARY

The present application provides a method for filtering and analyzing big data, an electronic device, and a non-transitory computer-readable storage medium to address the shortcomings in the prior art that only combined filtering can be performed for data under multiple dimensions, and to perform multiple rounds of filtering and analyzing for the data to obtain a more accurate filtering result.

According to an embodiment of the present application, there is provided a method for filtering and analyzing big data, including multiple rounds of filtering and analyzing. Each round of filtering and analyzing includes: filtering and analyzing a set of data to be filtered, according to a filtering dimension which was not selected; and saving data corresponding to at least one dimension item under the filtering dimension and satisfying at least one target requirement as a set of data to be filtered in a next round of filtering and analyzing. The number of the multiple rounds of filtering and analyzing is determined based on the number of filtering dimensions and target requirements.

According to another embodiment of the present application, there is further provided a non-transitory computer-readable storage medium storing executable instructions that, when executed by one or more processors, facilitates the execution of any one of methods of the present application as described above.

According to yet another embodiment of the present application, there is further provided an electronic device, the device includes at least one processor and a memory for storing instructions executable by the at least one processor, wherein execution of the instructions by the at least one processor causes the at least one processor to execute any one of methods of the present application as described above.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flow chart showing a filtering and analyzing method according to an embodiment of the present application;

FIG. 2 is a flow chart showing a filtering and analyzing method according to another embodiment of the present application;

FIG. 3 is a schematic diagram showing a structure of a filtering and analyzing system according to an embodiment of the present application; and

FIG. 4 is a schematic diagram showing a structure of an electronic device for implementing a filtering and analyzing method according to an embodiment of the present application.

### DETAILED DESCRIPTION

In order to make objects, technical solutions, and advantages of the present application more apparent, solutions of embodiments of the present application will be described clearly and completely in the following with reference to the drawings. Obviously, embodiments described herein are just some of embodiments of the present application, rather than all of them. Other embodiments obtained by those skilled in the art based on embodiments of the present application without making creative efforts fall within the scope of the present application.

It should be noted that embodiments of the present application and the technical features involved therein may be combined with each other in case they are not conflict with each other.

The present application is applicable to various general-purpose and specific-purpose computer system environments or configurations, such as a personal computer, a server computer, a handheld device or portable device, a tablet device, a multi-processor system, a microprocessor-based system, a set-top box, a programmable consumer electronic device, a network PC, a mini-computer, a mainframe computer, a distributed computing environment comprising any of the above-listed systems or devices, etc.

The present application can be described in a general context, where a computer executes computer-executable instructions, such as program modules. Typically, program modules include routines, programs, objects, components, data structures, etc., which perform certain tasks or implement certain abstract data types. The present application can also be implemented in a distributed computing environment, where tasks are performed by a remote processing device connected through a communication network. In a distributed computing environment, program modules may be stored in storage mediums comprising memory device of the local and remote computer.

Finally, it should also be noted that wordings like first and second are merely for separating one entity or operation from the other, and is not intended to require or imply a relation or sequence among these entities or operations. Further, terms like “comprise,” “comprising,” and the like are to be construed as including not only the elements described, but also those elements not specifically described, or further comprising elements which are essential to such process, method, article, or device. Unless the context clearly requires, throughout the description and the claims, elements defined by recitation with “comprising . . . ” should not be construed as exclusive from the process, method, article, or device comprising said elements or other equivalent elements.

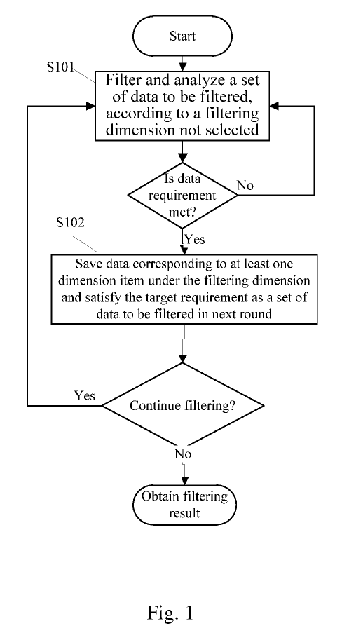

FIG. 1 is a flow chart of a filtering and analyzing method according to an embodiment of the present application. As shown in FIG. 1, the filtering and analyzing method includes multiple rounds of filtering and analyzing. Each round of filtering and analyzing may include the following steps.

In step S101, a filtering and analyzing server filters and analyzes a set of data to be filtered, according to a filtering dimension that was not selected.

In step S102, the filtering and analyzing server saves data corresponding to at least one dimension item under the filtering dimension and satisfying at least one target requirement as a set of data to be filtered in a next round of filtering and analyzing.

The number of the multiple rounds of filtering and analyzing is determined based on the number of filtering dimensions and target requirements.

The filtering and analyzing server in the embodiment of the application can set attributes of data in advance and set appropriate attributes as filterable attributes to obtain filtering dimensions. For video data, the filtering dimensions may include, for example region, city, operating system, browser, sex, age group, etc. Items under each dimension are specific class items of the filtering dimension. For example, dimension items under the filtering dimension of region may be regions in terms of geographical location (such as north region, south region, etc.), regions in terms of residential community, regions in terms of commercial circle, or regions in terms of administrative district (such as Beijing, Shanghai, etc.)

The target requirement serves as the basis for filtering and analyzing the data to be filtered, and can be considered as the filtering result required to be obtained by the filtering and analyzing server. For example, the target requirement may be that the obtained data has a maximum value, a minimum value, a smoothest trend, etc. Based on filtering dimensions and target requirements, the filtering and analyzing server can obtain the desired filtering result from the set of data to be filtered. The number of rounds of filtering and analyzing (i.e., the number of rounds of filtering and analyzing required to obtain the desired filtering result) is determined by the number of dimensions and the target requirements. For example, the number of rounds of filtering and analyzing does not exceed the number of filtering dimensions. If the filtering and analyzing server obtains the filtering result satisfying the target requirement during the filtering and analyzing process, then the filtering and analyzing process ends and the number of rounds of filtering and analyzing is determined accordingly.

In the filtering and analyzing method of the embodiment of the present application, the filtering and analyzing server performs multiple rounds of filtering and analyzing on the data according to multiple filtering dimensions to obtain the filtering result. Except for the first round of filtering and analyzing, each round of filtering and analyzing takes the filtering result of the last round of filtering and analyzing as the set of data to be filtered in the current round of filtering and analyzing, so that each round of filtering and analyzing processes a smaller amount of data than the last round of filtering and analyzing. Therefore, as compared with the prior art, in which combined filtering is performed at one time under multiple filtering conditions, the filtering and analyzing method of the embodiment of the application is less likely to cause the system to crash due to being heavily loaded with a large amount of data. Moreover, by setting a target requirement to be satisfied in each round of filtering and analyzing based on a reference value of the set of data to be filtered under a filtering item in this round of filtering, the accuracy of filtering and analyzing is improved.

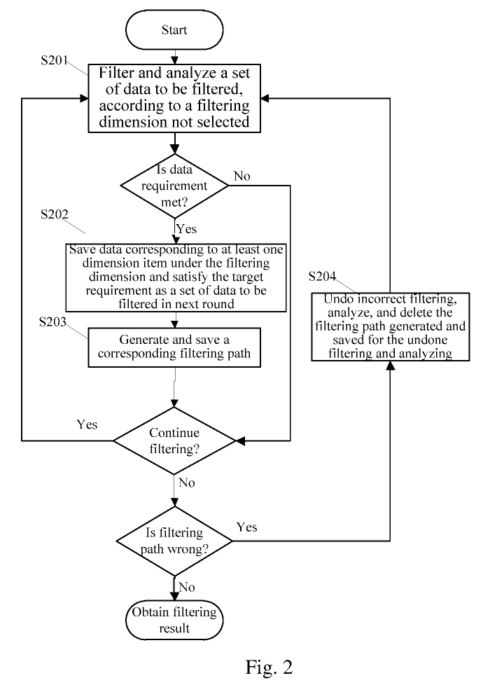

FIG. 2 is a flow chart showing a filtering and analyzing method according to another embodiment of the application. As shown in FIG. 2, the filtering and analyzing method may include multiple rounds of filtering and analyzing. Each round of filtering and analyzing includes the following steps.

In step S201, a filtering and analyzing server filters and analyzes a set of data to be filtered, according to a filtering dimension that was not selected.

In step S202, the filtering and analyzing server saves data corresponding to at least one dimension item under the filtering dimension and satisfying at least one target requirement as a set of data to be filtered in a next round of filtering and analyzing.

In step S203, the filtering and analyzing server generates and saves a corresponding filtering path.

The number of the multiple rounds of filtering and analyzing is determined based on the number of filtering dimensions and target requirements.

Compared with the method shown in FIG. 1, the filtering and analyzing method of the embodiment shown in FIG. 2 further includes step S203, at which the filtering and analyzing server generates and saves a corresponding filtering path, after step S202, at which the data corresponding to the at least one dimension item under the filtering dimension and satisfying the target requirement as the set of data to be filtered in the next round of filtering and analyzing.

By way of step S203, after each round of filtering and analyzing, its filtering path is saved. As such, when the filtering result of the data to be processed obtained by this round of filtering and analyzing is queried later, the saved filtering path is used as the entry of a combined query, and the same filtering result can be obtained by filtering once, thereby reducing the burden for the system to perform multiple rounds of filtering and analyzing.

In the filtering and analyzing method of the embodiment shown in FIG. 2, if no data satisfying the target requirement is obtained by a round of filtering and analyzing, and if no new filtering dimension is selected for performing filtering and analyzing, then it indicates that the previous filtering path is wrong. In this case, the method further includes a step S204, at which the filtering and analyzing server undoes the incorrect filtering and analyzing and deletes the filtering path generated and saved for the undone filtering and analyzing.

During the filtering and analyzing process, if it is found that the dimension item selected in a round is incorrect and the filtering path is wrong, this round of filtering and analyzing is undone and the filtering path is deleted, so that the data resulting from multiple rounds of filtering and analyzing (except the current round of filtering and analyzing) becomes the set of data to be filtered in the next round of filtering and analyzing. This thereby avoids the trouble of reselecting, from the original data, filtering dimensions of dimension items or the dimension items excluding the filtering dimension of the dimension item in the current round of filtering and analyzing or the dimension item to perform filtering and analyzing.

As a further optimization of the method embodiment shown in FIG. 1 or 2, the target requirement in the embodiment of the application is that: the set of data to be filtered includes data having a maximum value, the set of data to be filtered includes data having a minimum value, and an absolute difference between the maximum value and the minimum value is greater than a predetermined threshold; or data under each dimension item has a variation range broader than a predetermined range, the variation range representing a variation of a value of the data relative to a reference value. The predetermined threshold, the reference value, and the predetermined range is determined based on historical data in a historical database.

The embodiment of the application can take a large amount of historical resulting data stored by the system as references and set thresholds and ranges based thereon. The maximum value of the set of data under a dimension item, the minimum value of the set of data under a dimension item, and the predetermined threshold or the reference value and the predetermined range are used to perform filtering and analyzing, and the filtering result of each round of filtering and analyzing is saved in the historical database as a guidance to subsequent filtering and analyzing. The historical database may be continuously expanded and updated with more accurate data. In this way, as compared with the prior art, in which filtering and analyzing is performed based on the selection made according to personal experiences, the accuracy is improved.

It should be noted that the foregoing embodiments are described as a combination of a series of actions for the sake of brief description. However, the application is not restricted by the order of actions as described, as some steps in the present application may be carried out in a different order or simultaneously. Further, it should also be understood that some actions or modules involved therein are not essential to the present application. In the above embodiments, a different emphasis is placed on respective embodiments, and hence for those portions without a detailed description in an embodiment, reference can be made to relevant portions in other embodiments.

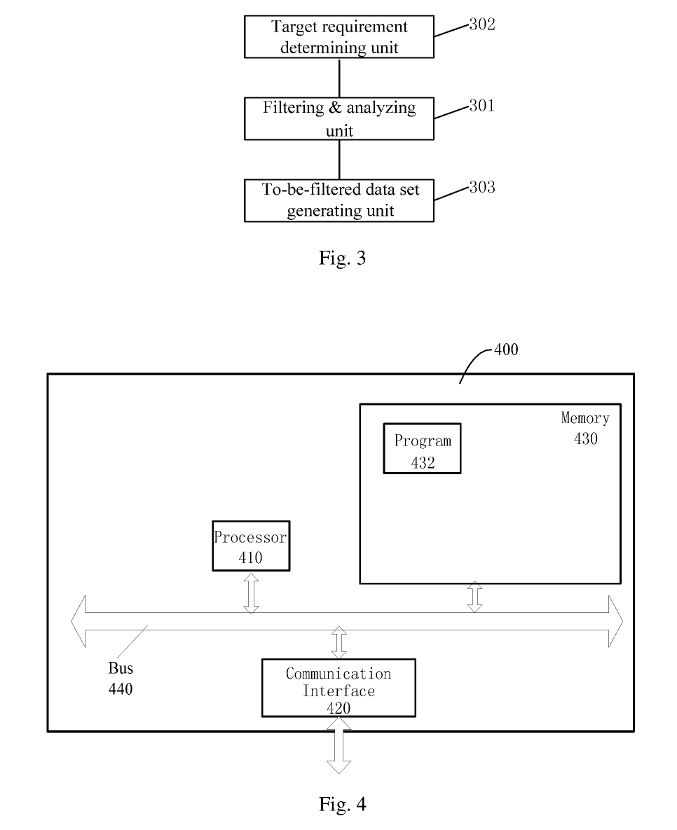

FIG. 3 is a schematic diagram showing a structure of a filtering and analyzing system according to an embodiment of the application. The filtering and analyzing method according to the application can be implemented by the filtering and analyzing system, according to the embodiment. As shown in FIG. 3, the filtering and analyzing system includes a filtering and analyzing unit 301, a target requirement determining unit 302, and a to-be-filtered data set generating unit 303.

The filtering and analyzing unit 301 is configured to filter and analyze a set of data to be filtered which are generated by the to-be-filtered data set generating unit 303, according to a filtering dimension that was not selected.

The target requirement determining unit 302 is connected to the filtering and analyzing unit 301, and is configured to provide at least one target requirement. The provided target requirement may include: a requirement that the set of data to be filtered includes data having a maximum value, a requirement that the set of data to be filtered includes data having a minimum value, and a requirement that an absolute difference between the maximum value and the minimum value is greater than a predetermined threshold; or a requirement that data under each dimension item has a variation range broader than a predetermined range, the variation range representing a variation of a value of the data relative to a reference value.

The to-be-filtered data set generating unit 303 is connected to the filtering and analyzing unit 301, and is configured to save data, which corresponds to at least one dimension item under the filtering dimension of a current round of filtering and analyzing performed by the filtering and analyzing unit 301. This satisfies the target requirement provided by the target requirement determining unit 302, as a set of data to be filtered in a next round of filtering and analyzing.

In the filtering and analyzing system of an embodiment of the application, the filtering and analyzing unit 301 may perform multiple rounds of filtering and analyzing on the data according to multiple filtering dimensions to obtain the filtering result. For each round of filtering and analyzing (except the first round of filtering and analyzing), the to-be-filtered data set generating unit 303 takes the filtering result of the last round of filtering and analyzing as the set of data to be filtered in this round of filtering and analyzing, so that each round of filtering and analyzing processes a smaller amount of data than the last round of filtering and analyzing. Therefore, compared with the prior art, in which combined filtering is performed at one time under multiple filtering conditions, the filtering and analyzing method of the embodiment of the application is less likely to cause a system crash due to a heavy load caused by a large amount of data. Moreover, by setting a target requirement provided by target requirement determining unit 302 to be satisfied in each round of filtering and analyzing based on a reference value of the set of data to be filtered under a filtering item in the current round of filtering, the accuracy of filtering and analyzing is improved.

The filtering and analyzing system of the present embodiment may be implemented, for example, as a server or a cluster of servers, with each unit being an individual server or server cluster. In this case, interactions among the units may appear as interactions among servers or server clusters corresponding to the units. The servers or server clusters together may constitute the filtering and analyzing system of the present application. Specifically, the multiple servers or server clusters which together constitute the filtering and analyzing system of the application may include the following servers or server clusters:

A filtering and analyzing server or server cluster configured to filter and analyze a set of data to be filtered, which are generated by the to-be-filtered data set generating server or server cluster, according to a filtering dimension which was not selected.

A target requirement determining server or server cluster configured to provide at least one target requirement. The provided target requirement may include: a requirement that the set of data to be filtered includes data having a maximum value, a requirement that the set of data to be filtered includes data having a minimum value, and a requirement that an absolute difference between the maximum value and the minimum value is greater than a predetermined threshold; or a requirement that data under each dimension item has a variation range broader than a predetermined range, the variation range representing a variation of a value of the data relative to a reference value.

A to-be-filtered data set generating server or server cluster is configured to save data corresponding to at least one dimension item under the filtering dimension of a current round of filtering and analyzing performed by the filtering and analyzing server and server cluster, which satisfies the target requirement provided by the target requirement determining server and server cluster, as a set of data to be filtered in a next round of filtering and analyzing.

In an alternative embodiment, some of the above units may together constitute a server or server cluster. For example, the filtering and analyzing unit and the to-be-filtered data set generating unit may together constitute a first server or server cluster, and the target requirement determining unit may constitute a second server or server cluster.

In this case, interactions among the above units may appear as interactions between the first server and the second server or interactions between the first server cluster and the second server cluster, and the first server and the second server or the first server cluster and the second server cluster together may constitute the filtering and analyzing system of the application.

As a further optimization of the system shown in FIG. 3, the filtering and analyzing system of the embodiment shown in FIG. 3 may further include a filtering path processing unit 304 connected to the to-be-filtered data set generating unit 303. The filtering path processing unit 304 is configured to generate and save a corresponding filtering path, after the data corresponding to the at least one dimension item under the filtering dimension and satisfying the target requirement provided by the target requirement determining unit 302 is saved as the set of data to be filtered in the next round of filtering and analyzing.

In an embodiment of the application, after each round of filtering and analyzing, the filtering path processing unit 304 saves its filtering path. As such, when the filtering result of the data to be processed obtained by this round of filtering and analyzing is queried later, the saved filtering path is used as the entry of a combined query, and the same filtering result can be obtained by filtering once, thereby reducing the burden for the system to perform multiple rounds of filtering and analyzing.

The filter path process unit in this embodiment may be a server or server cluster. In this case, interaction among the filtering path processing unit and all units in the embodiment shown in FIG. 3 may appear as an interface among servers or server clusters corresponding to the units. The servers or server clusters together may constitute the filtering and analyzing system of the present application.

In an alternative embodiment, some of the above units may together constitute a server or server cluster. For example, the filtering and analyzing unit and the to-be-filtered data set generating unit together may constitute a first server or server cluster, the target requirement determining unit may constitute a second server or server cluster, and the filtering path processing unit may constitute a third server or server cluster.

In this case, interactions among the above units may appear as interactions among the first server to the third server or interactions among the first server cluster to the third server cluster, and the first server to the third server or the first server cluster to the third server cluster together may constitute the filtering and analyzing system of the application.

As a further optimization of the system of embodiment shown in FIG. 3, the filtering path processing unit 304 in the embodiment of the application is further configured to delete a filtering path generated and saved for a round of filtering and analyzing after this round of filtering and analyzing is undone.

During the filtering and analyzing process, if it is found that the dimension item selected in a round is incorrect and the filtering path is wrong, this round of filtering and analyzing is undone and the filtering path is deleted by the filtering path processing unit 304, so that the data resulting from multiple rounds of filtering and analyzing except this round of filtering and analyzing becomes the set of data to be filtered in the next round of filtering and analyzing. This thereby avoids the trouble of reselecting, from the original data, filtering dimensions of dimension items or the dimension items excluding the filtering dimension of the dimension item in this round of filtering and analyzing or the dimension item to perform filtering and analyzing.

As a further optimization of the embodiment of the embodiment shown in FIG. 3, the filtering and analyzing system of the embodiment of the application may further include a predetermined threshold determining unit 305 and a historical database 306 connected to the target determining unit 302. The predetermined threshold determining unit 305 is configured to determine the predetermined threshold, the reference value, and the predetermined range, based on historical data in the historical database 306. The historical database 306 is capable of being updated based on results of the multiple rounds of filtering and analyzing. For video data, for example, some data in the historical database may be uploaded by a user device via a network.

The predetermined threshold determining unit and the historical database may be individual servers or server clusters, respectively. In this case, interaction among the predetermined threshold determining unit, the historical database, and the units in the above embodiment may appear as an interaction among servers or server clusters corresponding to the units. The servers or server clusters together may constitute the filtering and analyzing system of the application.

In an alternative embodiment, some of the above units may together constitute a server or server cluster. For example, the filtering and analyzing unit and the to-be-filtered data set generating unit together may constitute a first server or server cluster, the target requirement determining unit, the predetermined threshold determining unit and the historical database together may constitute a second server or server cluster, and the filtering path processing unit may constitute a third server or server cluster.

In this case, interactions among the above units may appear as interactions among the first server to the third server or interactions among the first server cluster to the third server cluster, and the first server to the third server or the first server cluster to the third server cluster together may constitute the filtering and analyzing system of the application.

Related functional modules in the embodiment of the application may be implemented, for example, by a hardware processor. Furthermore, an embodiment of the present application also provides a non-transitory computer-readable storage medium storing executable instructions, which may be executed by one or more processors (e.g., a hardware processor) to perform any one of methods of the present application as described above.

FIG. 4 is a schematic diagram illustrating a structure of an electronic device such as a server 400 according to an embodiment of the application. The specific implementation of server 400 is not limited by the particular embodiment of this application. As shown in FIG. 4, server 400 may include a processor 410, a communication interface 420, a memory 430, and a communication bus 440. Processor 410, communication interface 420, and memory 430 may communicate with one another via communication bus 440.

Communication interface 420 may be configured to perform communications with network elements, such as a client, a server, etc. Processor 410 may be configured to execute a program 432 to perform related steps in the above-described method embodiment. Specifically, program 432 may include program codes which include computer operable instructions.

Processor 410 may be implemented as a central processing unit (CPU) or an application specific integrated circuit (ASIC), or may be configured as one or more integrated circuits which implement the embodiment of this application.

In the server of the above embodiment, the memory may be configured to store computer operable instructions. The processor may be configured to execute the computer operable instructions stored in the memory, so as to perform the following operations of: filtering and analyzing a set of data to be filtered, according to a filtering dimension which was not selected; and saving data corresponding to at least one dimension item under the filtering dimension and satisfying at least one target requirement as a set of data to be filtered in a next round of filtering and analyzing.

In the following, the application will be further explained by taking an example where the amounts of users' video traffic are checked in the field of video.

For example, when a company intends to check the amounts of traffic used by users for watching video during a certain period of time on a service platform, it first sets multiple filtering dimensions, such as region, operating system, browser, etc. Under each filtering condition, there are respective dimension items. For example, regions include Beijing, Shanghai, Tianjin, and Guangdong province of China, etc. Operating systems may include, for example, Windows, Android and IOS systems. Browsers may include, for example, 360, Baidu, and Google browsers.

In an embodiment, the filtering and analyzing system may perform a first round of filtering and analyzing as follows.

The to-be-filtered data set generating unit takes data in the original database (i.e., the amounts of traffic used by users for watching video) as a set of data to be filtered. A filtering dimension (for example, region) is randomly selected, and the filtering and analyzing unit performs filtering under the filtering dimension. The target requirement determining unit determines the target requirement in this round of filtering and analyzing as finding the maximum and minimum amounts of users' traffic for items under the region dimension. In this case, the difference between the maximum amount and the minimum amount may be greater than a predetermined threshold. The predetermined threshold may be determined by the predetermined threshold determining unit and the historical database as 1,000 T.

The filtering and analyzing unit obtains the amounts of traffic used by users in Beijing, Shanghai, Tianjin, Guangdong, etc., for watching video as follows: users in Beijing use 568 T, users in Shanghai use 642 T, users in Tianjin use 295 T, and users in Guangdong use 1,546 T. Then, the maximum amount is 1,546 T in Guangdong, the minimum amount is 295 T in Tianjin, and the difference between the maximum amount and the minimum amount is 1,251 T, which is greater than the predetermined threshold of 1,000 T. The amounts of traffic under the dimension items of Guangdong and Tianjin satisfy the target requirement, so the to-be-filtered data set generating unit saves the amounts of traffic used in Guangdong and Tianjin as the set of data to be filtered in the next round of filtering and analyzing. Moreover, as shown in step S203, after the to-be-filtered data set generating unit saves the set of data to be filtered in the next round of filtering and analyzing, the filtering path processing unit generates and saves a corresponding filtering path.

Then, the filtering and analyzing system performs a second round of filtering and analyzing as follows.

The set of data to be filtered has become the amounts of traffic used by users in Tianjin and Guangdong for watching video. The operating system dimension is selected as the filtering dimension in this round of filtering and analyzing. The target requirement determining unit determines the target requirement in this round of filtering and analyzing as finding the maximum amount of users' traffic for items under the operating system dimension. In this case, the difference between the maximum amount and the minimum amount may be greater than a predetermined threshold. The predetermined threshold in this round of filtering and analyzing is determined by the predetermined threshold determining unit and the historical database as 50 T.

Steps S202 and S203 may be repeated. Specifically, the filtering and analyzing unit obtains the amounts of traffic used by users in Guangdong for watching video using Windows, Android, and IOS operating systems as 658 T, 423 T, and 460 T respectively, and obtains the amounts of traffic used by users in Tianjin for watching video using Windows, Android, and IOS operating systems as 132 T, 95 T, and 60 T respectively. From these, it is calculated that the maximum amount of traffic used by users in Guangdong is 658 T, the minimum amount of traffic used by users in Guangdong is 423 T, and the difference between the maximum amount and the minimum amount is 235 T. Furthermore, it is calculated that the maximum amount of traffic used by users in Tianjin is 132 T, the minimum amount of traffic used by users in Tianjin is 60 T, and the difference between the maximum amount and the minimum amount is 72 T. The difference between the maximum amount and the minimum amount is greater than the predetermined threshold for each of Guangdong and Tianjin, so the amount of traffic used by users in Guangdong using Windows systems and the amount of traffic used by users in Tianjin using Windows systems satisfy the target requirement.

Therefore, the to-be-filtered data set generating unit saves the amount of traffic used by users in each of Guangdong and Tianjin for watching video using Windows systems as the set of data to be filtered in the next round of filtering and analyzing. Moreover, as shown in step S203, after the to-be-filtered data set generating unit saves the set of data to be filtered in the next round of filtering and analyzing, the filtering path processing unit generates and saves a corresponding filtering path.

Then, the filtering and analyzing system performs a third round of filtering and analyzing.

The filtering dimension is the browser dimension, items under which are 360, Baidu, and Google browsers. The target requirement determining unit determines the target requirement in this round of filtering and analyzing as finding the maximum amount of users' traffic for items under the browser dimension, with the maximum amount and the minimum amount being greater than a predetermined threshold. The predetermined threshold in this round of filtering and analyzing is determined by the predetermined threshold determining unit and the historical database as 3 times the minimum amount of traffic for the items.

The filtering and analyzing unit obtains the amounts of traffic used by Windows users in Guangdong for watching video using 360, Baidu, and Google browsers as 75 T, 31 T, and 158 T respectively, and obtains the amounts of traffic used by Windows users in Tianjin for watching video using 360, Baidu, and Google browsers as 12 T, 5 T, and 23 T. From these, it is determined that the maximum amount of traffic used by Windows users in Guangdong is 158 T, the minimum amount of traffic used by Windows users in Guangdong is 31 T, and the difference between the maximum amount and the minimum amount is 127 T, which is greater than the predetermined threshold of 92 T. Furthermore, it may be determined that the maximum amount of traffic used by Windows users in Tianjin is 23 T, the minimum amount of traffic used by Windows users in Tianjin is 5 T, and the difference between the maximum amount and the minimum amount is 18 T, which is greater than the predetermined threshold of 15 T. The difference between the maximum and minimum amounts of traffic used by windows users in each of Guangdong and Tianjin for its respective items in this round of filtering and analyzing is greater than the predetermined threshold, so the amount of traffic used by Windows users in Guangdong using Google browsers and the amount of traffic used by Windows users in Tianjin using Google browsers satisfy the target requirement.

Therefore, the to-be-filtered data set generating unit saves the amount of traffic used by Windows users in each of Guangdong and Tianjin for watching video using Google browsers as the set of data to be filtered in the next round of filtering and analyzing. Moreover, as shown in step S203, after the to-be-filtered data set generating unit saves the set of data to be filtered in the next round of filtering and analyzing, the filtering path processing unit generates and saves a corresponding filtering path.

After it is determined that filtering and analyzing under all filtering dimensions is completed, the filtering result is the set of data to be filtered obtained in the third round of filtering and analyzing. That is, the amounts of data used by Windows users in Guangdong and Tianjin using Google browsers. The filtering result is saved in the historical database for updating the historical database. The filtering path generated and saved by the filtering path processing unit in the third round of filtering and analyzing may be used as the entry of a combined query for later querying the amounts of data used by users for watching video during this certain period of time.

After the hardware processor and the service platform perform related functions and display the filtering result, the enterprise can determine that, in each of Guangdong and Tianjin, users watching video using Windows systems generate the most amount of traffic. Furthermore, the enterprise can determine that, among Windows users, those watching video using Google browsers generate the most amounts of traffic. From this information, conclusions can be drawn to assist the enterprise in making related decisions. For example, steps may be taken to prevent congestion caused by Windows users in Guangdong and Tianjin watching video at peak hours.

The target requirement in the embodiment may also be a requirement under another reference condition, such as the ranking of data for each region changes by two as compared with a reference value in the historical database. For example, when it is checked why availability of videos on a video website is low, filtering dimensions are set as region, operator, player, video ID, and watching ratio. The region dimension is first selected for expansion, the filtering and analyzing unit obtains, according to the target requirement, that the rank of video availability for Beijing changes by two or more than before, and the to-be-filtered data set generating unit selects the data corresponding to Beijing as the set of data to be filtered in the next round of filtering and analyzing.

Then, the watching ratio dimension is selected for filtering. Because there is no data satisfying the target requirement, the operator dimension is newly selected. For data under the dimension item of China Mobile selected by the filtering and analyzing unit, filtering is performed under the video ID dimension, so that data filtered sequentially according to the region (Beijing), operator (China Mobile) and video ID (video 1 and video 2) is obtained.

Then, the player dimension is selected for filtering, and no data satisfying the target requirement is found. By analysis, it is known that the filtering path of Beijing is wrong. The filtering path processing unit deletes the path of Beijing to obtain data filtered sequentially according to operator (China Mobile) and video ID (video 1 and video 2), and the obtained data is used by the to-be-filtered data set generating unit as the set of data to be filtered in the next round of filtering and analyzing. The player dimension is selected again to obtain data filtered sequentially according to operator (China Mobile), video ID (video 1 and video 2), and player (flash), so that the filtering and analyzing is completed. It is concluded that, in the network of China Mobile, the video availability of video 1 and video 2 opened with flash players is too low to drag down the video availability of the entire website. Problems causing dragging down of the video availability of the entire website can be addressed after they are found out. For example, video 1 and video 2 in the flash format may be deleted or uploaded again to improve user experience of the website.

The foregoing embodiments are illustrative, in which those units described as separate parts may or may not be separated physically. Illustrated components may or may not be physical units, i.e., may be located in one place or distributed in several locations among a network. Some or all modules may be selected according to practical requirement to realize the purpose of the embodiments, and such embodiments can be understood and implemented by the skilled person in the art without undue experimentation.

A person skilled in the art can clearly understand from the above description of embodiments that these embodiments can be implemented through software in conjunction with general-purpose hardware, or directly via hardware implementations. Based on such understanding, the essence of foregoing technical solutions, or those features making contribution to the prior art may be embodied as software product stored in computer-readable medium such as ROM/RAM, diskette, optical disc, etc., and including instructions for execution by a computer device (such as a personal computer, a server, or a network device) to implement methods described by foregoing embodiments or a part thereof.

Finally, it should be noted that the above embodiments are provided to describe the technical solutions of the present application, but are not intended as a limitation. Although the present application has been described in detail with reference to the embodiments, those skilled in the art will appreciate that the technical solutions described in the foregoing various embodiments can still be modified, or some technical features therein can be equivalently replaced. Such modifications or replacements do not make the essence of corresponding technical solutions depart from the spirit and scope of technical solutions embodiments of the present application.

What is claimed is:

1. A method for filtering and analyzing big data at an electronic device, comprising multiple rounds of filtering and analyzing, with each round of filtering and analyzing comprising:
filtering and analyzing a set of data to be filtered, according to a filtering dimension that was not selected; and
saving data corresponding to at least one dimension item under the filtering dimension and satisfying at least one target requirement as a set of data to be filtered in a next round of filtering and analyzing,
wherein the number of the multiple rounds of filtering and analyzing is determined based on a number of filtering dimensions and target requirements.

2. The method according to claim 1, wherein after saving the data corresponding to the at least one dimension item under the filtering dimension and satisfying the target requirement as the set of data to be filtered in the next round of filtering and analyzing, a corresponding filtering path is generated and saved.

3. The method according to claim 2, wherein each round of filtering and analyzing can be undone, and
wherein a filtering path that is generated and saved for a round of filtering and analyzing is deleted after a round of filtering and analyzing is undone.

4. The method according to claim 1, wherein the target requirement includes:
data under each dimension item in the set of data to be filtered has a maximum value or a minimum value, and an absolute difference between the maximum value and the minimum value is greater than a predetermined threshold, or
data under each dimension item has a variation range broader than a predetermined range, the variation range representing a variation of a value of the data relative to a reference value.

5. The method according to claim 4, wherein the predetermined threshold, the reference value, and the predetermined range are determined based on historical data stored in a historical database, and
wherein the historical database is configured to be updated based on results of the multiple rounds of filtering and analyzing.

6. A non-transitory computer-readable storage medium, storing executable instructions that, when executed by one or more processors associated with an electronic device, cause the electronic device to:
filter and analyze a set of data to be filtered, according to a filtering dimension that was not selected; and
save data corresponding to at least one dimension item under the filtering dimension and satisfying at least one target requirement as a set of data to be filtered in a next round of filtering and analyzing,
wherein the number of the multiple rounds of filtering and analyzing is determined based on a number of filtering dimensions and target requirements.

7. The non-transitory computer-readable storage medium according to claim 6, wherein after saving the data corresponding to the at least one dimension item under the filtering dimension and satisfying the target requirement as the set of data to be filtered in the next round of filtering and analyzing, the non-transitory computer-readable storage medium further comprising executable instructions that, when executed by the one or more processors, cause the electronic device to generate and save a corresponding filtering path.

8. The non-transitory computer-readable storage medium according to claim 7, wherein each round of filtering and analyzing can be undone, and
wherein a filtering path that is generated and saved for a round of filtering and analyzing is deleted after a current round of filtering and analyzing is undone.

9. The non-transitory computer-readable storage medium according to claim 6, wherein the target requirement includes:
data under each dimension item in the set of data to be filtered has a maximum value or a minimum value, and an absolute difference between the maximum value and the minimum value is greater than a predetermined threshold, or
data under each dimension item has a variation range broader than a predetermined range, the variation range representing a variation of a value of the data relative to a reference value.

10. The non-transitory computer-readable storage medium according to claim 9, wherein the predetermined threshold, the reference value, and the predetermined range is determined based on historical data stored in a historical database, and
wherein the historical database is configured to be updated based on results of the multiple rounds of filtering and analyzing.

11. An electronic device, comprising:
at least one processor; and
a memory communicably connected with the at least one processor and configured to store instructions executable by the at least one processor, wherein execution of the instructions by the at least one processor causes the at least one processor to:
filter and analyze a set of data to be filtered, according to a filtering dimension that was not selected; and
save data corresponding to at least one dimension item under the filtering dimension and satisfying at least one target requirement as a set of data to be filtered in a next round of filtering and analyzing,
wherein a number of the multiple rounds of filtering and analyzing is determined based on the number of filtering dimensions and target requirements.

12. The electronic device according to claim 11, wherein after saving the data corresponding to the at least one dimension item under the filtering dimension and satisfying the target requirement as the set of data to be filtered in the next round of filtering and analyzing,
wherein execution of the instructions by the at least one processor causes the at least one processor further to generate and save a corresponding filtering path.

13. The electronic device according to claim 12, wherein each round of filtering and analyzing can be undone, and
wherein a filtering path that is generated and saved for a round of filtering and analyzing is deleted after a round of filtering and analyzing is undone.

14. The electronic device according to claim 11, wherein the target requirement includes:
data under each dimension item in the set of data to be filtered has a maximum value or a minimum value, and an absolute difference between the maximum value and the minimum value is greater than a predetermined threshold, or
data under each dimension item has a variation range broader than a predetermined range, the variation range representing a variation of a value of the data relative to a reference value.

15. The electronic device according to claim 14, wherein the predetermined threshold, the reference value, and the predetermined range is determined based on historical data stored in a historical database, and
wherein the historical database is configured to be updated based on results of the multiple rounds of filtering and analyzing.
